(19) United States
(12) Patent Application Publication
(10) Pub. No.: US 2006/0242398 A1
(43) Pub. Date: Oct. 26, 2006

(54) Booting from non-volatile memory

(76) Inventors: Wilhelmus Franciscus Johannes Fontijn, Eindhoven (NL); Adrianus Johannes Maria Denissen, Eindhoven (NL); Robert Jochemsen, Eindhoven (NL); Nicolaas Lambert, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/558,734

(22) PCT Filed: May 25, 2004
(86) PCT No.: PCT/IB04/50766

§ 371 Date: Nov. 29, 2005

(30) Foreign Application Priority Data
Jun. 3, 2003 (EP) 03101613.2

(51) Int. Cl. G06F 9/00

(52) U.S. Cl. 713/2

(57) ABSTRACT

A computer system includes a system memory (SM) and a non-volatile memory (NVM). The computer system is arranged to copy at least a part of the system state, stored in the system memory during a clean boot-up procedure, into the non-volatile memory (209, 329). During subsequent start-ups of the computer system, the system state is copied from the non-volatile memory into the system memory (205, 305), resulting in a significantly faster system start-up. In case the configuration of the computer system has changed, the complete boot-up procedure is executed again and the new system state is copied into the non-volatile memory, overwriting the previously stored system state.

### TECHNICAL FIELD

The present invention relates to booting of a computer system.

### BACKGROUND ART

Computer systems, such as personal computers often utilize an initialization procedure during which a computer operating system is loaded. In general, the operating system for a computer system is stored on a non-volatile storage medium, such as a magnetic hard disk drive. However, the processor of the computer system executes instructions from the so-called system memory, which is an addressable memory such as DRAM. In order to initialize this addressable memory, a small amount of non-volatile boot-up memory is typically provided in a dedicated memory. The dedicated memory contains a program, the so-called basic input/output (BIOS) program, used for reading some initial portion of the operating system from the hard disk drive and loading it into the system memory. This portion of the operating system is then responsible for loading and initializing remaining portions of the operating system. This process is generally referred to as “booting” the operating system. After a computer initializes itself or “boots”, it is usually in a default state, ready for a user to initiate some program or process. Usually, the computer system is in the same state after every initialization, regardless of a user's past activities. The boot-up procedure executed when the computer system is turned on is usually referred to as a cold boot, whereas the boot-up procedure executed using {Ctrl}+{Alt}+{Delete} or similar is referred to as a warm boot. The boot-up procedure is a time consuming process, as it typically requires execution of the boot sequence stored on the boot device, including copying operating system files to the system memory. As a result, the user of a computer system has to wait quite some time after switching on the apparatus before he can actually start using it.

### DISCLOSURE OF INVENTION

It is an object of the invention to provide a computer system with an improved boot-up procedure, strongly reducing the time required for booting up the computer system.

This object is achieved with a computer system comprising a system memory and a non-volatile memory, the non-volatile memory being accessible by the system memory. The computer system is arranged to copy at least a part of the system state, stored in the system memory during a first boot-up procedure, into the non-volatile memory. When booting the computer system, a copy of the system state resulting from the first boot-up procedure is stored in the non-volatile memory. This copy of the system state can be used the next time the computer system is switched on to directly define the state obtained as a result of the boot-up procedure. Execution of the boot sequence stored on the boot device is not required as well as copying of operating system files to the system memory. Almost all processing during the boot-up procedure is eliminated, strongly reducing the time required for performing the boot-up procedure. Furthermore, the system state that is stored in the non-volatile memory is a clean and well-defined system state having no errors that can be introduced during use of the system after booting, for example.

U.S. Pat. No. 6,449,683B1 describes a computer system, including a non-volatile random-access memory coupled to a processor. Upon receiving or generating a command to enter a low-power mode, the processor allocates space in the memory for storing the operating states of system devices. Once the device states are stored to memory, the processor then asserts a command signal that instructs the computer system to enter the low-power mode. Upon detecting the restoration of power, the processor restores the device states from the allocated space in memory and then resumes normal operation.

U.S. Pat. No. 6,393,584B1 describes a computer system, including a processor and a hard disk drive. Upon receiving or generating a command to enter a “sleep” mode, a sleep file is created within the hard disk drive, which stores the operating state of the computer system. When the operating state has been stored, power is removed from the computer system. Upon start up, the operating system of the computer system is loaded and the operating state is restored from the sleep file on the hard disk drive. After restoration of the operating state, the computer system is in the same state that it was in prior to invoking the sleep state.

U.S. Pat. No. 6,098,158 discloses a computer system, including a processor, RAM storage and system memory. Any particular software application may initiate a so-called fast boot-up procedure. When executing the fast boot-up procedure, a boot image is saved in the RAM storage. One or more boot images may be stored in association with an initiating application. At a later moment in time, the boot image can be retrieved to system memory. Upon a given occurrence, such as a power outage or other system failure or interruption, the computer system is then restored to a given execution state from the boot image.

However, none of these documents discloses the principle of saving at least a part of a well-defined system state in a non-volatile memory, for enabling a fast cold boot of the computer system. U.S. Pat No. 6,449,683B1 and U.S. Pat. No. 6,393,584B1 focus on restoring the complete system state when recovering from a low-power mode, whereas U.S. Pat. No. 6,098,158 focuses on restoring the full system state when recovering from an error i.e. rather a fast warm boot than a fast cold boot.

Further embodiments of the invention are described in the dependent claims. According to the invention, a method for booting a computer system is claimed as well.

### BRIEF DESCRIPTION OF THE DRAWINGS

FIG. 1 is a schematic diagram showing a computer system according to the invention.

FIG. 2 is a flowchart showing general steps for booting a computer system according to the invention.

FIG. 3 is a flowchart showing steps for booting a computer system according to FIG. 1.

### DESCRIPTION OF PREFERRED EMBODIMENTS

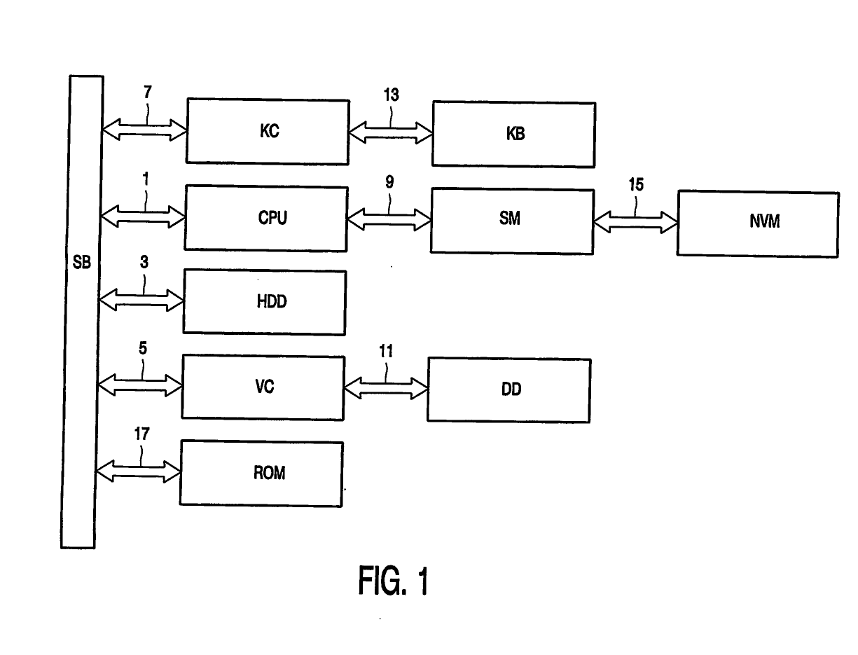

Referring to FIG. 1, a schematic block diagram illustrates a computer system in the form of a personal computer (PC), comprising a central processing unit CPU, a hard disk drive HDD, a system memory SM, a non-volatile memory NVM, a system bus SB, a video controller VC, a display device DD, a keyboard controller KC, a keyboard KB and a read-only memory ROM. The system bus SB is coupled to the central processing unit CPU via coupling 1, to the hard disk drive HDD via coupling 3, to the video controller VC via coupling 5, to the keyboard controller KC via coupling 7 and to the read-only memory ROM via coupling 17. The central processing unit CPU is coupled to the system memory SM via coupling 9, and the system memory SM is coupled to non-volatile memory NVM via coupling 15. The video controller VC is coupled to the display device DD via coupling 11. The keyboard controller KC, the central processing unit CPU, the hard disk drive HDD, the read-only memory ROM and the video controller VC are coupled via the system bus SB. In an alternative embodiment, the non-volatile memory NVM is coupled directly to the system bus SB and communicates with the system memory SM via the central processing unit CPU. The computer system is capable of executing a prerecorded list of instructions, such as programs or program modules, which causes the computer system to behave in a predetermined manner. Program modules may include routines, programs, objects, components, data structures, etc. that perform particular tasks or implement particular abstract data types.

In other embodiments, the computer system may comprise different devices, including a floppy disk drive, a printer, a mouse, a CD-ROM player, and a DVD player, for example.

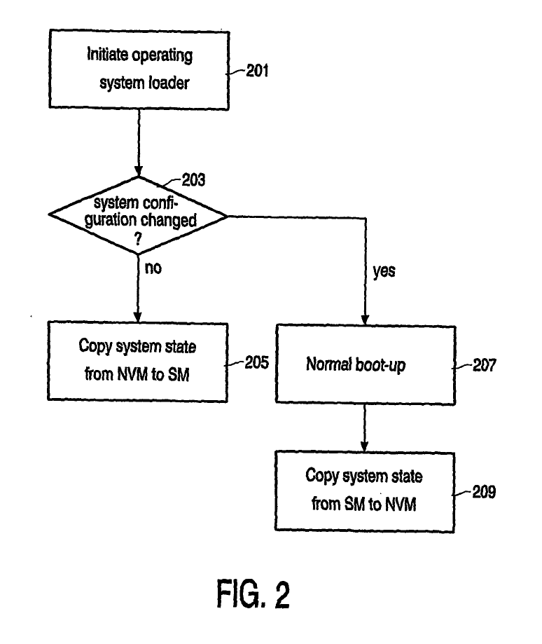

When the computer system according to FIG. 1 is turned on, it needs to find instructions immediately to tell the personal computer what to run in order to start up and these instructions it finds within the so-called Basic Input Output System (BIOS) program. The BIOS program is stored in read-only memory ROM, which is for example a FLASH memory being used as if it is a read-only memory. To run the BIOS program, the BIOS program is often loaded first from the read-only memory ROM into the system memory SM, via the system bus SB. FIG. 2 is a flowchart showing general steps for booting a computer system according to the invention. Referring to FIG. 2, when the computer system is turned on an operating system loader is initiated in step 201. In a next step 203, it is verified whether the configuration of the computer system has changed. If the system configuration has changed, the normal boot-up procedure is followed in step 207. In step 209, at least a part of the system state stored in the system memory SM during the boot-up procedure, is copied from the system memory SM to the non-volatile memory NVM. In case the system configuration has not changed, a second boot-up procedure is followed. In step 205 the system state stored in the non-volatile memory NVM is copied to the system memory SM. In parallel to step 205, some remaining initialization procedures may be executed, not shown in FIG. 2. The second boot-up procedure allows a very fast boot-up of the computer system in case the system configuration has not changed, since this boot-up procedure comprises a memory-to-memory copy of the result of the normal boot-up procedure. Furthermore, the second boot-up procedure is both independent of the platform and the operating system that is being used. It is also more stable and reliable than repeated hibernation, since the system state obtained after a clean boot-up procedure is stored in the non-volatile memory NVM, whereas in case of hibernation it can not be ensured that the system state does not comprise any errors introduced during use of the computer system after booting up.

Preferably, the non-volatile memory NVM comprises a magnetic random access memory (MRAM). MRAM allows a fast memory access, allowing the central processing unit CPU to retrieve the system state from the non-volatile memory NVM at a high speed, resulting in an increase in the performance of the computer system during the boot-up procedure.

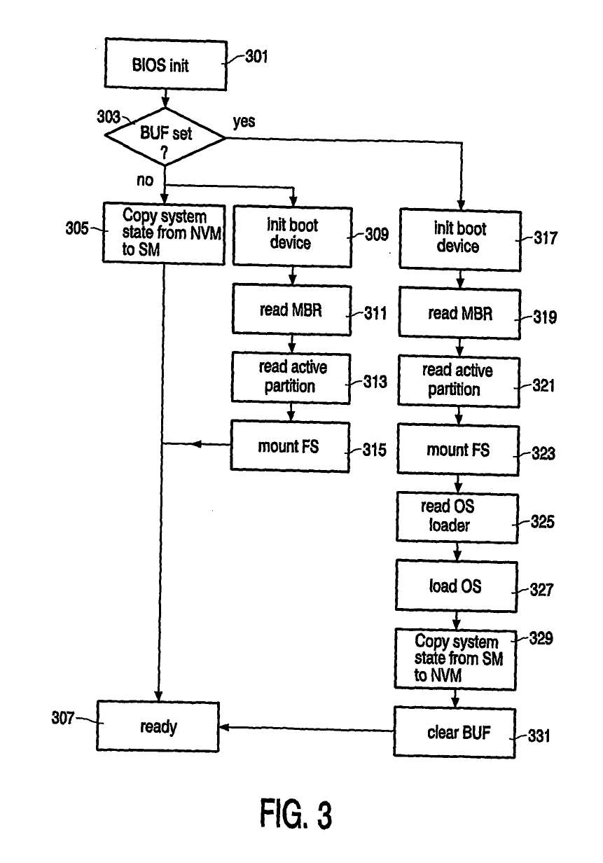

In a preferred embodiment, the computer system according to the invention comprises a boot update flag (BUF), which can be implemented as a dedicated register on the motherboard chipset. The BUF is set when it is likely that the system state as stored in the non-volatile memory NVM is not up-to-date, i.e. it does not reflect the current configuration of the computer system. For example, in case the casing of the computer system is opened it is likely that the hardware configuration has changed. The opening of the casing is detected by a physical switch, and the BUF is set. Other examples are when the operating system of the computer system has been updated, which is detected by a dedicated driver that sets the BUF, or in case of a change in settings of the network where the computer system is connected to. Yet another example is that the BUF can be set manually by means of a separate button on the computer system. Initially, i.e. the first time a computer system is powered up, the BUF will be set. In an alternative embodiment, a routine is implemented that verifies if changes in the system configuration have occurred. This routine may be combined with the BUF. In that case the BUF is set, if the routine detects a change in the system configuration. FIG. 3 is a flowchart showing a method for booting a computer system according to FIG. 1. Referring to FIG. 3, when the power is switched on, in step 301 the BIOS program is initialized, after it has been loaded into the system memory SM. Initialization of the BIOS program may include running the power-on self test (POST) as well as hardware initialization. A step 303, performed by the BIOS program, verifies whether the BUF is set. In case the BUF is set, a normal boot-up procedure is performed. In step 317 the boot device is initialized, and for the computer system shown in FIG. 1 the hard disk drive HDD is the boot device. The master boot record (MBR) is read from the hard disk drive HDD in step 319. A step 321 reads the active partition of the master boot record. In a step 323 the file system is mounted. A step 325 reads the operating system (OS) loader from the boot device. In step 327 the operating system is loaded in the system memory SM. A copy of the system memory SM, i.e. a copy of the system state, is made and stored in the non-volatile memory NVM in step 329. A step 331 resets the value of the BUF. Step 307 shows that the computer system is ready for use. In case the BUF is not set, a second boot-up procedure is followed. In step 305 the system state stored in the non-volatile memory NMV is copied to the system memory SM. In parallel to step 305, the boot device in the form of the hard disk drive HDD is initialized in step 309. The master boot record (MBR) is read from the hard disk drive HDD in step 311. A step 313 reads the active partition of the master boot record. In a step 315 the file system is mounted. After finishing steps 305 and 315, the computer system is ready for use in step 307. In case the computer system does not respond within a chosen time interval after performing step 305, an error may have occurred and the operating system of the computer system will enforce a cold boot. The steps executed during the normal boot-up procedure described in this embodiment are steps that typically occur in a boot-up procedure. In other embodiments, however, different steps may be executed, depending on which devices are present in a computer system, the BIOS program and the manufacturer of the hardware, to name a few.

The system state that is copied to the non-volatile memory NVM in step 329 is the state as stored in the system memory SM, and it is assumed that all other volatile memory in the computer system, such as buffers, registers or caches not being part of the system memory SM, are empty after the normal boot-up procedure. If this is not the case, these buffers, registers or caches may have to be flushed, i.e. reset, not shown in FIG. 3, before copying the system state stored in system memory SM to the non-volatile memory NVM in step 329. In this way it is ensured that the content of non-volatile memory NVM after performing step 329, is a complete representation of the state of the computer system.

In the present embodiment, step 329 copies all system state stored in system memory SM after completion of the boot-up procedure to non-volatile memory NVM. In other embodiments, only a part of the system state is copied to non-volatile memory NVM by using a driver that initiates step 329 as soon as the amount of occupied memory in the system memory SM approximates the space reserved in non-volatile memory SM for storing of the system state. Alternatively, copying of a part of the system state to non-volatile memory NVM can be initiated by a user pressing a dedicated button, or at a well defined point in the boot-up procedure, for example at the moment a user has to log-in. In case only a part of the system state obtained until a certain point in the boot-up procedure is stored in non-volatile memory NVM, after performing step 305 the part of the boot-up procedure that has not been executed from said point onwards still has to be executed.

In yet another embodiment the amount of system state that is saved in the non-volatile memory NVM in step 329 is made dependent on the user, in case of a plurality of users working on the same computer system. For example, for the most frequent users a larger amount of system state is saved when compared to the less frequent users, allowing the first group of users to have a relatively faster boot-up procedure.

In some embodiments a plurality of different system states is saved in the non-volatile memory NVM, by repeating the steps 317-331 for different types of operating systems or for several instances of an operating system. As a result, the user may switch between two or more operating systems without the need of a cold boot of the computer system.

In different embodiments the computer system may comprise other system configurations, such as hand-held devices, multiprocessor systems, microprocessor-based or programmable consumer electronics, network PCs, minicomputers, mainframe computers and the like.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. In the device claim enumerating several means, several of these means can be embodied by one and the same item of hardware. The mere fact that certain measures are recited in mutually different dependent claims does not indicate that a combination of these measures cannot be used to advantage.

1. A computer system comprising:
a system memory (SM),
a non-volatile memory (NVM), the non-volatile memory being accessible by the system memory,
wherein the computer system is arranged to copy at least a part of the system state, stored in the system memory during a first boot-up procedure, into the non-volatile memory (209, 329).

2. A computer system according to claim 1, wherein the computer system is further arranged to copy the system state stored in the non-volatile memory into the system memory during a second boot-up procedure of the computer system (205, 305).

3. A computer system according to claim 2, wherein the computer system is further arranged to execute either the first boot-up procedure or the second boot-up procedure, dependent on whether the configuration of the computer system has changed.

4. A computer system according to claim 3, wherein the computer system further comprises a dedicated register flag indicating whether the configuration of the computer system has changed.

5. A computer system according to claim 1, characterized in that the non-volatile memory comprises a magnetic random access memory.

6. A method for booting a computer system, comprising a first boot-up procedure,
wherein the computer system comprises:
a system memory (SM),
a non-volatile memory (NVM), the non-volatile memory being accessible by the system memory,
and wherein the first boot-up procedure comprises the steps:
performing the boot sequence stored on the boot device (207),
copying at least a part of a system state, stored in the system memory during performance of the boot sequence, into the non-volatile memory (209, 329).

7. A method for booting a computer system according to claim 6, characterized in that the method further comprises a second boot-up procedure,
wherein the second boot-up procedure comprises the step: copying the system state stored in the non-volatile memory into the system memory (205, 305).
